(19) United States
(12) Patent Application Publication
(10) Pub. No.: US 2012/0131180 A1
(43) Pub. Date: May 24, 2012

(54) SERVER SYSTEM AND METHOD FOR MANAGING THE SAME

(75) Inventors: Ken Nomura, Yokohama (JP); Tadashi Takeuchi, Tokyo (JP)

(73) Assignee: Hitachi Ltd.

(21) Appl. No.: 12/996,739

(22) PCT Filed: Nov. 19, 2010
(86) PCT No.: PCT/JP2010/006786

§ 371 Date: Dec. 7, 2010

(51) Int. Cl. G06F 15/173

(52) U.S. Cl. 709/224

(57) ABSTRACT

Provided is a technique for adequately allocating hardware resources of physical hardware to virtual hardware that operates on the physical hardware, and achieving a server integration effect in accordance with the performance of the physical hardware. According to the present invention, before resources are added to the virtual hardware, the residual amount of the resources in the entire physical hardware and resources that will run short in the virtual hardware are predicted, so that a server configuration is changed in accordance with the prediction result, and resources that are actually running short in the virtual hardware are supplemented.

### TECHNICAL FIELD

The present invention relates to a server technology for providing services via a network, for example.

### BACKGROUND ART

Nowadays, various servers are providing various services over the Internet or intranets of enterprises. Many servers are operated 24 hours, and a reduction in the operation management cost such as by power saving is indispensible. Under such circumstances, hardware virtualization technology has been gaining increased attention. Hardware virtualization technology refers to a technology of virtually implementing a plurality of pieces of hardware on a single piece of physical hardware via emulation. With the hardware virtualization, it is possible to easily integrate processes, which have been conventionally executed by separate pieces of hardware, on a single piece of physical hardware. The reasons that such a technology can reduce the operation management cost are as follows. First, a server is originally constructed from server software and physical hardware that executes the software. However, regardless of whether the server software is performing some processes or not, typical physical hardware would consume about the same amount of electric power. Thus, if all pieces of physical hardware on a server with a low utilization rate are simply replaced by virtual hardware (VM: Virtual Machine) and are integrated on a single piece of physical hardware, it becomes possible to reduce the number of pieces of physical hardware to be managed and also reduce the power consumption, installation cost of the physical hardware, and the like.

Meanwhile, with regard to servers with high utilization rates such as servers that use much memory space or servers that use many CPUs, it is expected that combining servers that require different hardware resources will achieve a server integration effect. However, it is difficult to adequately allocate the minimum required amount of hardware resources in advance to virtual hardware on each server, in particular, in an environment in which services should be provided to an indefinite number of clients over a large enterprise's intranet or the Internet. This is because allocation of hardware resources that are necessary to execute a server would vary in a complicated manner depending on the difference in the performance of individual clients that are connected to the server, or the difference in the channel quality between each client and the server, round-trip time (round-trip delay time), and the like, and thus it would be difficult to predict how many clients under what conditions are to be connected to which server.

Nonetheless, if hardware resources are simply allocated evenly across a plurality of pieces of virtual hardware, a specific server will run short of hardware resources, which can cause a performance bottleneck, with the result that a server should be added onto another new physical hardware. Thus, it would be impossible to achieve a server integration effect as is expected. In other words, there is a problem that in order to integrate servers on the minimum required number of pieces of physical hardware, it would be necessary to adequately and dynamically allocate hardware resources of the physical hardware to virtual hardware and thereby maximize the inherent performance of the hardware.

In order to address such a problem, using the technique disclosed in Patent Literature 1, for example, can dynamically adjust resources allocated to the virtual hardware that executes the server based on the server load status.

### CITATION LIST

### Patent Literature

PTL 1: JP Patent Publication No. 2010-33292 A

### SUMMARY OF INVENTION

### Technical Problem

However, even when the technique of Patent Literature 1 is used, it would be impossible to adequately allocate hardware resources of the physical hardware in a well-balanced manner to the virtual hardware and thereby maximize the inherent performance of the hardware.

That is, when the existing techniques including the technique of Patent Literature 1 or a combination thereof is used, it would be only possible to supplement resources that have been detected to be deficient. Thus, even when there are other available resources of the physical hardware (resources other than those that have been detected to be deficient), such resources cannot be fully utilized.

According to the existing techniques including the technique of Patent Literature 1 or a combination thereof, it is possible to adjust the amount of resources allocated to the virtual hardware by collecting unused resources from the virtual hardware or by conversely adding resources to the virtual hardware. Meanwhile, as the resource adjustment process itself would also consume resources, the maximum performance would degrade by the amount of such resource consumption. In particular, at a performance near the maximum performance of the physical hardware, the server would be overloaded due to the influence of the resource adjustment process, whereby the performance would degrade significantly.

That is, it is impossible with the existing techniques or a combination thereof to adequately allocate hardware resources of physical hardware in a well-balanced manner to virtual hardware that operates on the physical hardware. Thus, as the inherent performance of the hardware cannot be obtained, there is a problem that a server integration effect through the virtualization cannot be fully achieved.

The present invention has been made in view of the foregoing circumstances, and provides a technique for adequately allocating hardware resources of physical hardware in a well-balanced manner to virtual hardware that operates on the physical hardware to thereby maximize the inherent performance of the hardware and fully achieve a server integration effect through the virtualization.

### Solution to Problem

In order to solve the aforementioned problem, according to the server system of the present invention, when a margin of resources has become lower than a predetermined value due to an increase in the load on the server software, the resource adjustment process is halted, and resources that have been allocated to the resource adjustment process are released so as to be allocated to virtual hardware that executes the server software. In addition, the amount of resources that are necessary for the resource adjustment process is calculated dynamically, and if the load on the virtual server has become lower than the amount of resources necessary for the resource adjustment process, the resource-balancing process is re-started.

Further, before resources are added to the virtual hardware, the residual amount of resources in the entire physical hardware as well as resources that will run short in the virtual hardware are predicted, and a server configuration is changed in accordance with the prediction result. Then, resources that are actually running short in the virtual hardware are supplemented.

In addition, the maximum performance of a server executed by the same hardware is predicted, so that connection to the server is restricted using the predicted value of the maximum performance.

Further, even when the virtual hardware is overloaded or operates abnormally due to a change in the configuration of the software on the virtual hardware, the interrupt state on the virtual hardware is monitored.

That is, in the server system of the present invention, a plurality of virtual servers to each of which a plurality of types of hardware resources is allocated is managed. Such virtual servers are operated based on their respective server configurations. In the server system, management information of virtual hardware, which is the plurality of types of hardware resources allocated to each of the plurality of virtual servers, is managed on memory. In the server system, a virtual server that is short of resources is detected based on the use rate of the virtual hardware in each of the plurality of virtual servers, and excess resources that can be allocated are also determined from the use rate. In addition, in the server system, it is determined if allocation of additional resources to the virtual server, which is short of resources, is possible based on the calculated excess resources. If the allocation of the additional resources to the virtual server is determined to be impossible, the virtual hardware allocated to the virtual server is released and the operation of the virtual server is halted.

Further, in the server system of the present invention, for each of the plurality of virtual servers, a future use rate of the virtual hardware is predicted based on information on the past use rate of the virtual hardware. Then, based on the predicted future use rate, deficient resources and excess resources in the future are predicted. Based on a combination of the deficient resources and the excess resources, an adjustment condition for the server configuration of the virtual server is acquired, and the server configuration of the virtual server is adjusted in accordance with the adjustment condition.

### Advantageous Effects of Invention

According to the present invention, hardware resources of physical hardware can be adequately allocated in a well-balanced manner to virtual hardware that operates on the physical hardware, whereby the inherent performance of the hardware can be maximized and a server integration effect through the virtualization can be fully achieved.

It should be noted that objects, configurations, and operational effects other than those described above will become apparent from the following embodiments for carrying out the present invention and the accompanying drawings.

### BRIEF DESCRIPTION OF DRAWINGS

FIG. 1 is a diagram showing an exemplary configuration of a computer system in accordance with the first embodiment of the present invention.

FIG. 2 is a diagram showing an exemplary configuration of a disk device in accordance with an embodiment of the present invention.

FIG. 3 is a diagram showing an exemplary configuration of a resource management table.

FIG. 4 is a flowchart for illustrating an algorithm of a main program.

FIG. 5 is a diagram for illustrating the overview of a method of predicting a shortage of resources.

FIG. 6 is a diagram showing an exemplary structure of a server configuration table for determining a server configuration content.

FIG. 7 is a diagram for illustrating the role of setting an I/O scheduling cycle.

FIG. 8 is a diagram for illustrating the role of setting a block I/O queue length.

FIG. 9 is a diagram for illustrating the role of setting the alignment of a block I/O.

FIG. 10 is a flowchart for illustrating an operation algorithm of a server configuration adjustment program.

FIG. 11 is a diagram for illustrating the overview of a method of predicting the maximum performance.

FIG. 12 is a flowchart for illustrating an operation algorithm of a performance prediction program.

FIG. 13 is a flowchart for illustrating an operation algorithm of a resource allocation adjustment program.

FIG. 14 is a flowchart for illustrating an operation algorithm of a control module booting/halting program.

FIG. 15A is a flowchart (1) for illustrating operation algorithms of a virtual hardware protection program.

FIG. 15B is a flowchart (2) for illustrating operation algorithms of a virtual hardware protection program.

FIG. 16 is a flowchart for illustrating an operation algorithm of an initialization program.

FIG. 17 is a diagram showing an exemplary configuration of a computer system in accordance with the second embodiment of the present invention.

FIG. 18 is a flowchart for illustrating an operation algorithm of a main program in accordance with the second embodiment of the present invention.

FIG. 19 is a flowchart for illustrating an operation algorithm of a load generation program in accordance with the second embodiment of the present invention.

FIG. 20 is a flowchart for illustrating an operation algorithm of a report output program in accordance with the second embodiment of the present invention.

FIG. 21 is a diagram showing an exemplary report of a performance measurement result in accordance with the second embodiment of the present invention.

### DESCRIPTION OF EMBODIMENTS

Hereinafter, an embodiment of the present invention will be described with reference to the accompanying drawings. It should be noted that this embodiment is merely illustrative for carrying out the present invention, and is not intended to limit the technical scope of the present invention. Structures that are common throughout the drawings are assigned the same reference numbers.

In this specification, information used in the present invention is represented by a “table:” However, such information can also be represented by a “chart,” “list,” “DB,” or “queue,” or data structures other than the list, DB, or queue. Therefore, a “table,” “chart,” “list,” “DB,” “queue,” or the like may sometimes be referred to as “information” in order to show that the information used in the present invention does not depend on the data structure.

In the description of the content of each information, expressions such as “identification information,” “identifier,” “name,” “appellative,” and “ID” are used. Such expressions are interchangeable.

Further, in the following description of the processing operation of the present invention, each operation may be described as being performed by a “program” or a “module.” However, since it is only after a program or a module is executed by a processor that the program or the module can perform a given process using memory or a communication port (a communication control device), each operation can also be read as being performed by a processor. Further, a process disclosed as being performed by a program or a module can also be performed by a computer or an information processing device of a server or the like. Further, part or the whole of a program can be implemented by dedicated hardware. A variety of programs can be installed on each computer via a program distribution server or a storage medium.

### (1) First Embodiment

The first embodiment of the present invention will describe a case in which allocation of resources to virtual hardware should be continuously adjusted dynamically when, for example, services are provided to an indefinite number of client terminals over the Internet.

<System Configuration>

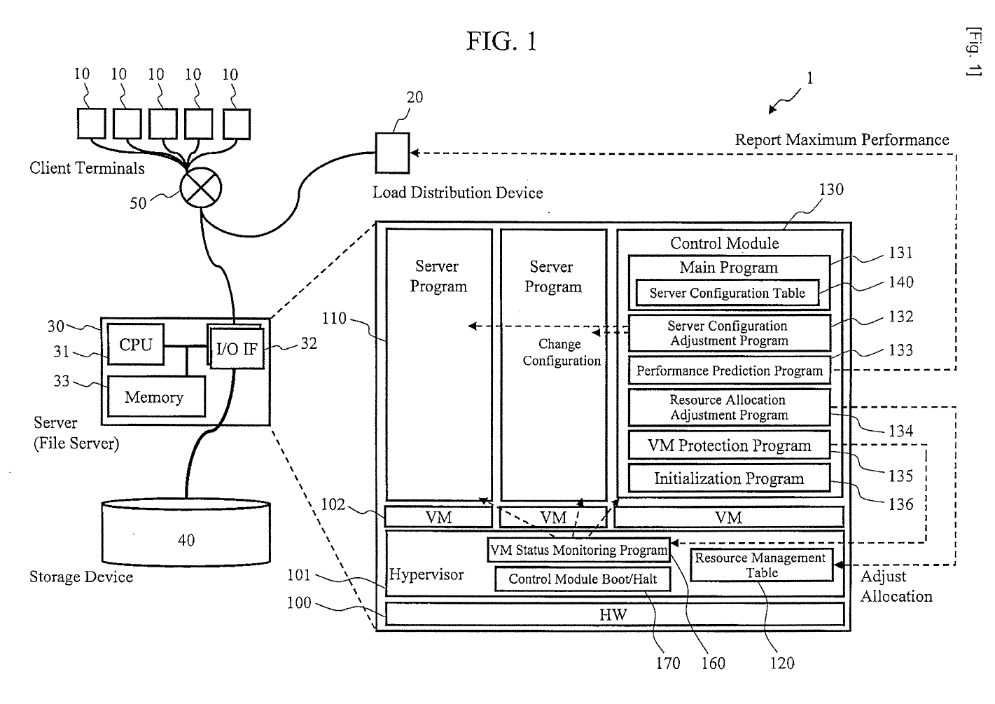

FIG. 1 is a diagram showing the configuration of a computer system 1 in accordance with the first embodiment of the present invention. The computer system 1 includes at least one client terminal 10, at least one load distribution device 20, at least one server 30, and a network 50 that mutually connects them.

The client terminal 10 is connected to the server 30 via the network 50, and receives a service provided by a server program 110 running on the server 30. For example, when the server program 110 is a server such as a web server that distributes content services, the client terminal 10 downloads a webpage and contents such as a movie or music, which are stored in a storage device 40 in advance, via the server program 110, and displays them on a monitor of the client terminal 10.

Although services such as those described above can be provided to the plurality of client terminals 10 using a single server program 110, there is a limitation in the number of client terminals 10 that can be connected to a single server program 110 or a single server 30. Therefore, when services are provided to a number of client terminals 10, access from the client terminals 10 is distributed across a plurality of servers 30 and server programs 110 using the load distribution device 20.

Specifically, the client terminal 10 is connected first to the load distribution device 20, and inquires about the address of the server 30. Next, in the simplest method, for example, the load distribution device 20 has an address list of the servers 30, and sequentially returns the addresses of different servers 30 in the list each time the client terminal 10 inquires about the address. Then, the client terminal 10 is connected to the server 30 with the address obtained as a result of the inquiry, and thus receives a service. Such procedures allow a load to be distributed such that the number of the client terminals 10 connected to each server program 110 is constant. It should be noted, however, that even when the number of the client terminals 10 connected to each individual server program 110 is made constant, resources consumed by each server program 110 will not necessarily be constant due to the aforementioned influence of the channel quality or the like between each client terminal 10 and the server program 10, and the influence of the usage status of a service. As used herein, “influence of the usage status of a service” refers to a circumstance in which resources consumed on the server would differ depending on the way in which a service is used (e.g., whether web pages are to be sequentially browsed, or a single piece of video data with a large file size is to be viewed). That is, even when a plurality of server programs 110 of the same type are executed, the way in which resources are consumed by each server program would differ as if a plurality of server programs 110 of different types is being executed. Further, as the resource consumption amount can be known only after the client terminals 10 are actually connected, it is difficult with the load distribution device 20 on the stage preceding or following the server 30 to distribute a load such that the resource consumption of each server can be equal.

<Server Internal Configuration>

Next, the physical internal configuration of the server 30 will be described. The server 30 includes a CPU 31, I/O interfaces 32, memory 33, and a storage device 40 connected to one of the I/O interfaces 32. The storage device 40 can be connected to the server 30 via a network. Such a configuration can be applied not only to the server 30, but also to the client terminal 10 and the load distribution device 20. Each device is connected to the network 50 via the I/O interface.

The CPU 31 executes programs stored in the memory 33, thereby implementing the logical configuration of the server 30 described below. It should be noted that the programs on the memory 33 will be lost once the power of the server 30 is turned Off. Thus, such programs are typically stored in the storage device 40 in advance so that they are read into the memory 33 at the moment when the power is turned On.

The logical configuration of the server 30 includes a hypervisor 101, which operates directly on hardware 100 having the aforementioned CPU 31, the I/O interface 32, and the like; several pieces of virtual hardware 102 implemented by the hypervisor 101; a server program 110 that runs on the virtual hardware 102; and a control module 130. The “hypervisor” herein refers to a control program for implementing the virtual hardware, and can be entirely implemented by software or be implemented by use of a hardware virtualization function. To be more precise, typically, an operating system (OS) corresponding to virtual hardware, which is implemented by the hypervisor, operates on the virtual hardware, and the server program 110 and the control module 130, which are applications, operate on the OS. It should be noted that the content (each program or table) of the control module 130 can be provided in the hypervisor 101, but is provided as shown in FIG. 1 because the server system in accordance with this embodiment can be implemented using the existing hypervisor (however, the content of a resource management table 120 and the like should be changed).

Next, individual programs of the control module 130 and the hypervisor 101 will be described. The control module 130 includes a server configuration adjustment program 132, a performance prediction program 133, a resource allocation adjustment program 134, a virtual hardware protection program 135, an initialization program 136, a server configuration table 140, and a main program 131 that controls each of the aforementioned programs.

The hypervisor 101 includes, in addition to the basic function for implementing the virtual hardware, a virtual hardware status monitoring program 160, a control module booting/halting program 170, and the resource management table 120.

Through a cooperative operation of a series of such programs, the control module 130 configures the server program 110 and adjusts hardware resources allocated to the virtual hardware 102, which executes the server program 110, via the hypervisor 101. The details of each program will be described later.

<Configuration of the Storage Device>

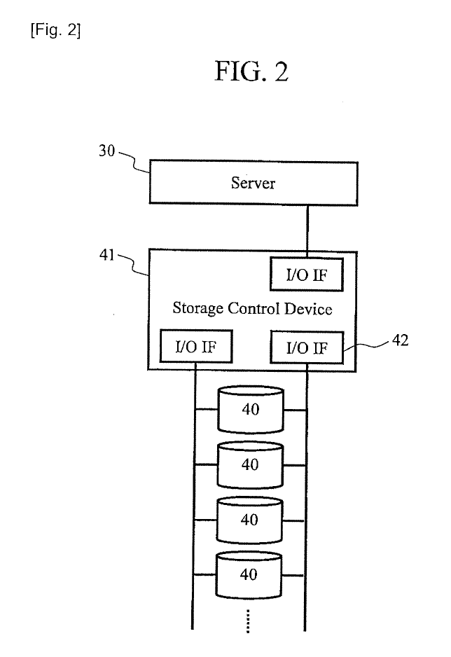

FIG. 2 is a diagram for supplementarily illustrating the configuration of the storage device 40 that can be provided in accordance with this embodiment of the present invention. The storage device 40 can be connected to the server 30 not only directly but also via a storage control device 41. Accordingly, even when a huge storage area is created by combining storage areas of a plurality of storage devices 40 that is connected to an I/O interface 42 of the storage control device 41 or when a failure has occurred in the storage device 40, the server 30 is able to record data in a distributed manner across the plurality of storage devices 40 to prevent a data loss, so that more reliable storage areas can be used.

<Resource Management Table>

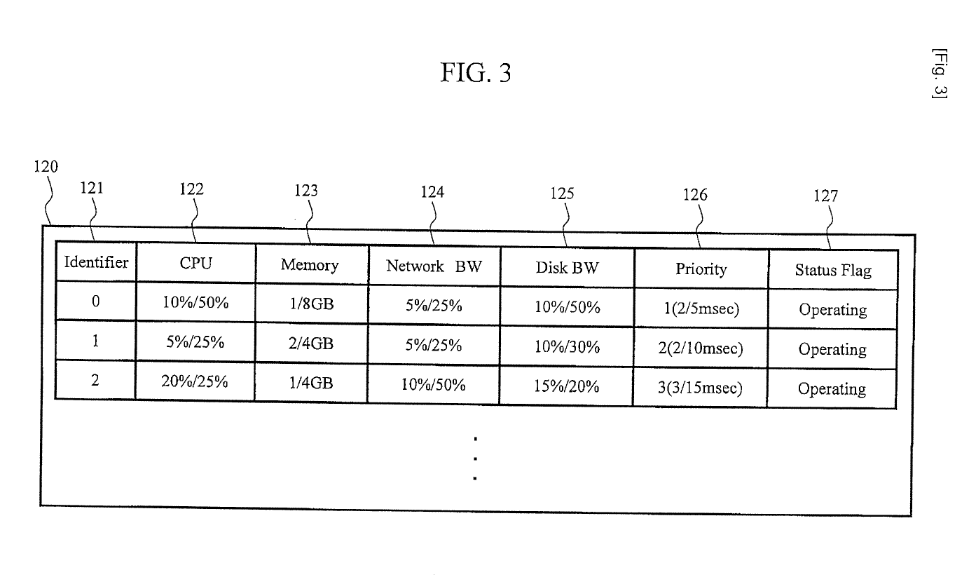

FIG. 3 is a diagram showing an exemplary configuration of the resource management table 120. The resource management table 120 indicates how hardware resources of the physical hardware 100 are allocated to the virtual hardware 102. When the allocation amount in the table is changed, the amount of hardware resources that are actually allocated to the associated virtual hardware 102 by the hypervisor 101 is also changed as defined in the table. It should be noted that unallocated resources can be managed by, for example, being allocated to the virtual hardware 102 that executes the control module 130, being allocated to imaginary virtual hardware 102 that does not exist in reality, or being allocated to none of the virtual hardware.

The resource management table 120 contains virtual hardware identifier 121 for identifying the virtual hardware 102, for example; CPU resource amount 122, memory resource amount 123, network bandwidth resource amount 124, and disk bandwidth resource amount 125, which are allocated to the virtual hardware 102; execution priority 126 that would influence the response performance of the virtual hardware; and a status flag 127 that indicates the status (e.g., operating or halting) of the virtual hardware.

Each item of the table includes two values: the used amount and the allocated amount of the resources. The used amount is represented by, in the case of the CPU resource amount 122, for example, the ratio of the used CPU resource amount (e.g., 10% in the case of the virtual hardware with the identifier “0”) to the allocated CPU resource amount (50%). The memory resource amount 123 is represented by the ratio of the number of used bytes (1 GB) to the number of allocated bytes (8 GB). The execution priority 126 is represented by the ratio of the actual response performance value (2 msec) to the response performance requirement (5 msec) managed by software on the virtual hardware 102. When the actual response performance value exceeds the response performance requirement, in the case of image distribution, for example, the image being distributed will be frozen. In such a case, other virtual hardware is halted to control the actual response performance value such that it is within the response performance requirement.

When CPU resources are added to the virtual hardware 102, for example, the value of the CPU resource amount 122 (the amount of the allocated resources) of the virtual hardware corresponding to a virtual hardware number 121 of “0” in the resource management table is increased. Naturally, the sum of the CPU resource amounts 122 allocated to all pieces of the virtual hardware 102 should be less than or equal to the hardware resource amount of the physical hardware 100. This is also true of the other resources such as the memory resource amount 123 and the network bandwidth resource amount 124.

Specific procedures for realizing the addition and collection of hardware resources are broadly divided into two. The first method is a method of letting hardware resources, which are seen from the virtual hardware 102, appear as if there is a predetermined sufficient amount of resources regardless of the amount of the actually allocated resources. This method is advantageous in that as the resources are disguised as being existing from the beginning, it is not necessary to, when resources are added, inform the OS and the server program 110 on the virtual hardware 102 of the addition of the resources. However, when some of the resources such as memory resources are collected, it is necessary to acquire information about which area of the memory area allocated to the virtual hardware 102 is an unused area and execute garbage collection as needed. As used herein, “garbage collection” refers to a process of integrating fractionally distributed small free spaces into a large, contiguous free space. The garbage collection is typically executed periodically by the server program 110 or the OS thereof. If all of the resources of the physical hardware have been used up and a shortage of resources occurs, there is a problem that software on the virtual server would see it as if a hardware failure has occurred, not a shortage of resources. Further, there is another problem that the process of the virtual hardware cannot be continued until new resources are secured with some methods.

The second method is a method of adequately modifying hardware resources seen from the virtual hardware 102 each time resources are added or collected. When this method is used, it is naturally necessary to inform, each time resources are added, the OS and the server program 110 on the virtual hardware 102 of the addition of the resources. Meanwhile, when resources such as memory resources are collected, it is also necessary to, after garbage collection is executed as needed, the OS and the server program 110 on the virtual hardware of the reduction of the resources. However, as the amount of resources seen from the virtual hardware and the amount of the actually allocated resources are equal, there is no possibility that software on the virtual server would see that a hardware failure has occurred due to a shortage of resources, or the process of the virtual hardware 102 cannot be continued.

In either of the aforementioned methods, when resources are added to or collected from the virtual hardware 102, it is necessary to execute a series of the accompanying processes such as garbage collection using the hypervisor 101 or software on the virtual hardware 102.

<Process of the Control Module>

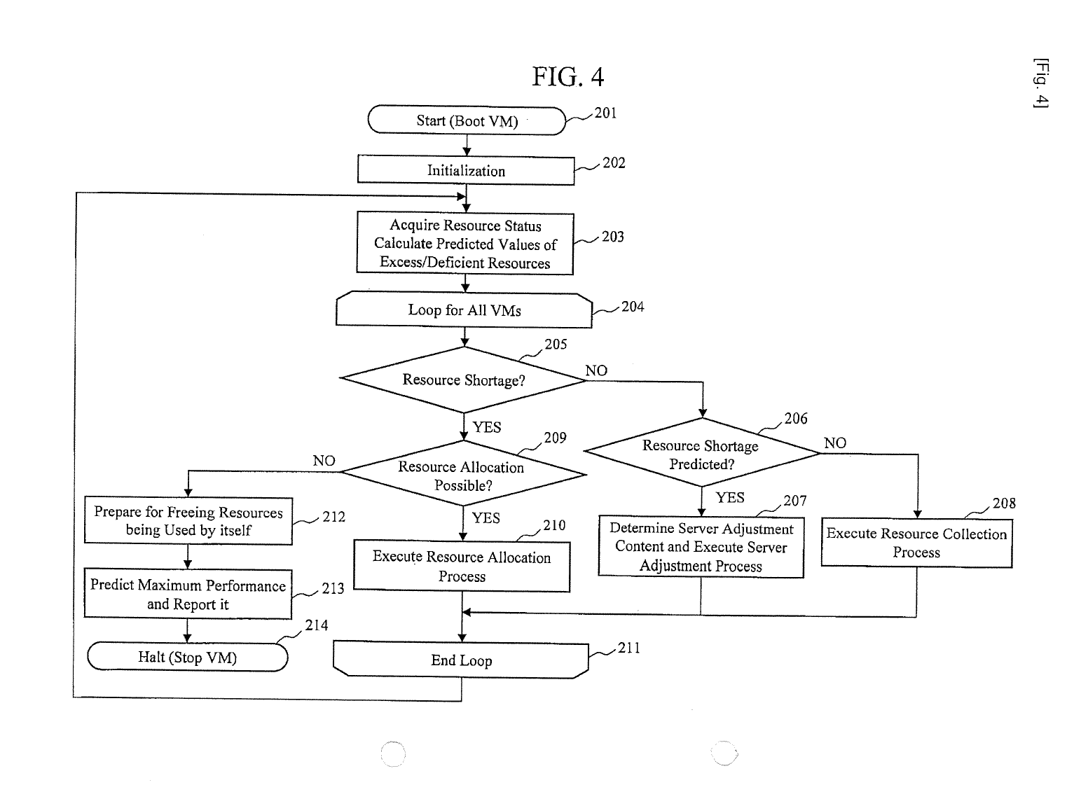

FIG. 4 is a flowchart for illustrating the process of the main program 131 that is the central to the control module 130. Similar to the server program 110, the control module 130 is a program executed on the virtual hardware 102, and is started when the virtual hardware 102 is booted. Specifically, the main program 131 is executed first among the programs in the control module 130. The primary role of the main program 131 is to reference the server configuration table 140, the server configuration adjustment program 132, and the resource allocation adjustment program 134 as needed and adjust a server configuration in accordance with a future predicted excess or shortage of resources, and to collect the excess resources and supplement resources that are running short. Hereinafter, the details of the operation algorithm of the main program 131 will be described.

First, execution of the main program 131 starts when the virtual hardware 102 is booted (step 201). The main program 131 performs initialization using the initialization program 136 only immediately after the start of its execution (step 202). In the initialization, the first to fourth thresholds, which are described later, and the amount of resources to be allocated and collected in a single process are determined (also referred to as an update step, a change amount, or a changing step) based on the administrator's entry or on a prescribed value.

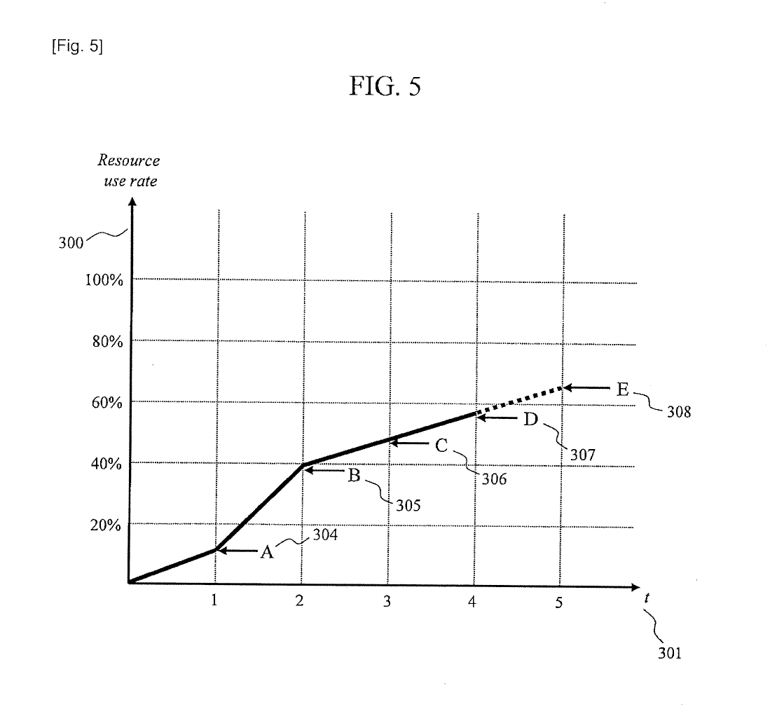

Next, the main program 131 references the content of the resource management table 120 managed by the hypervisor 101 to obtain the number of pieces of the virtual hardware 102 being executed and the amount of resources allocated to the individual virtual hardware 102. Then, the main program 131 calculates future predicted values of excess resources and deficient resources with the procedures described below (step 203). The calculation of the predicted values will be described later with reference to FIG. 5.

Next, the main program 131 executes the processes of step 204 to step 211 to all pieces of the virtual hardware 102 described in the resource management table 120. Specifically, the main program 131 checks for the presence of a resource whose used amount relative to the allocated amount is over the first threshold, which has been determined in the aforementioned initialization (step 205). If there is no resource whose used amount relative to the allocated amount is over the first threshold (if the answer to step 205 is No), the main program 131 determines that there are sufficient resources at the moment.

Then, the main program 131 checks for the presence of a resource whose future predicted value of the resource allocation status calculated in step 203 is over the second threshold, which has been determined in the aforementioned initialization (step 206). In the presence of a resource whose value is over the second threshold (if the answer to step 206 is Yes), the main program 131 references the server configuration table 140 described below to prepare for a shortage of resources, which may occur in the future, determines the server adjustment content, and invokes the server configuration adjustment program 132 described below to execute a process of adjusting the server configuration (step 207). Meanwhile, if there is no resource whose value is over the second threshold (if the answer to step 206 is No), the main program 131 determines that there will be no shortage of resources for the moment, invokes the resource allocation adjustment program 134 described below, and, if there are any resources that are allocated in excess, beyond the third threshold, which has been determined in the aforementioned initialization, collects such resources (step 208). Then, the process proceeds to step 211 described below, whereupon the process for a single piece of the virtual hardware 102 terminates.

If a resource whose value is over the first threshold is determined to be present in step 205 (if the answer to step 205 is Yes), the main program 131 determines that the resource is running short, and checks the residual amount of the hardware resources acquired in step 203 to see if the residual amount of the allocatable resources is over the fourth threshold, which has been determined in the aforementioned initialization, that is, if resource allocation is possible (step 209).

If resource allocation is determined to be possible (if the answer to step 209 is Yes), the main program 131 invokes the resource allocation adjustment program 134 described below, and executes a process of adding the resource (step 210). Then, the processes of step 204 to step 211 are repeated (step 211), and when the processes have been executed to all pieces of the virtual hardware 102, the flow returns to step 203 to repeat the processes.

Meanwhile, if the residual amount of the allocatable resources is determined to be below the fourth threshold in step 209, that is, if there is a shortage of the allocatable resources (if the answer to step 209 is No), the main program 131 prepares for releasing the resources used by the control module 130 and the virtual hardware 102 that executes the control module 130, thereby clarifying the amount of resources that can be obtained by halting the virtual hardware (step 212).

Then, the main program 131 invokes the performance prediction program 133 described below, and predicts the maximum performance of the server program 110 of when the resources used by the module 130 are allocated to the server program 110, and then reports the maximum number of connected clients, which is the predicted value, to the load distribution device 20 (step 213).

Further, the main program 131 halts the virtual hardware 102, releases the resources, and completes the allocation of the resources to the server program 110. As the final sequence of the processes includes halting the main program 131 itself, the main program 131 issues a halt instruction to the control module booting/halting program 170 that operates within the hypervisor 101 so that the control module booting/halting program 170 executes the halting (step 214). Then, the released resources of the halted virtual hardware 102 are instructed to be allocated to another virtual hardware 102.

<Process of Predicting the Amount of Resources>

FIG. 5 is a diagram for illustrating the basic process of predicting the amount of resources in step 203 of the main program 131. In FIG. 5, the vertical axis 300 indicates the resource consumption rate (use rate), while the horizontal axis 301 indicates the elapse of time. Each of reference numerals A304, B305, and C306 represents the actual value of the resource use rate in the past. Provided that the current resource use rate is D307, the future resource use rate E308 can be represented by E=alpha*D+(1-alpha)*X using the previously predicted value X and the weight constant alpha (0<1=alpha<1=1). It should be noted that the initial value of X is zero, and the predicted value XB of B when the initial resource consumption rate A304 is measured can be represented by XB=alpha*A. In addition, the predicted value XC of C when the resource consumption rate 13305 is measured is given by XC=alpha*B+(1-alpha)*alpha*A.

Through the aforementioned procedures, it is found that a resource whose consumption rate is expected to be the highest is a resource that is predicted to run short, and a resource whose consumption rate is predicted to be the lowest is a resource that is predicted to be in excess. It should be noted that methods other than the aforementioned method can be used for the resource prediction procedures. Further, a different prediction procedure can be used for each resource.

<Server Configuration Table>

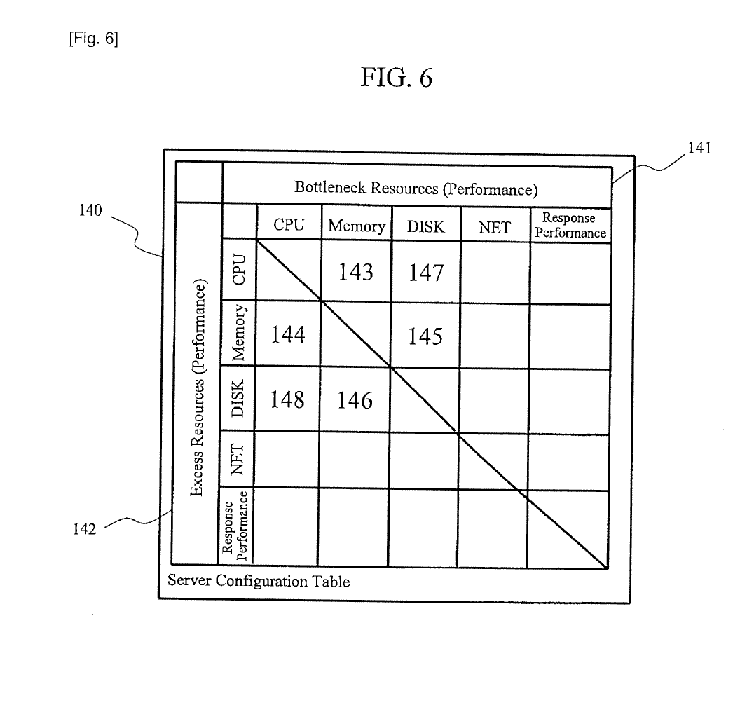

FIG. 6 is a diagram showing an example of the server configuration table 140 for determining a server configuration content. In the server configuration table 140, horizontal items 141 and vertical items 142 each include hardware resources such as CPU, memory, disk bandwidth, network bandwidth, and response performance. Among such items, the response performance is the time it takes for the server 30 to provide a service to the client terminal 10. Such item may not be called a hardware resource depending on the way in which the “hardware” is defined. However, in order to transmit and smoothly reproduce image or sound streams, it is indispensable that the response performance should meet the requirement. Otherwise, if the response performance cannot meet the requirement, it can be a bottleneck so that the hardware cannot attain its maximum inherent potential performance as in the case in which other resources would run short. Therefore, in this embodiment, the response performance is handled as a hardware resource. Specifically, provided that the response performance requirement is 100 msec and the current actual response performance value is 1 msec, the response performance can be regarded as consuming 1% of the resources. Meanwhile, if the actual response performance value reaches or exceeds the performance requirement of 100 msec, the resource consumption amount is regarded as 100%. Accordingly, the response performance can be handled as about an equal resource to other hardware resources.

The difference between the horizontal item 141 and the vertical item 142 in the table is that the horizontal item 141 in the table indicates a candidate resource that is predicted to run short, while the vertical item 142 indicates a candidate resource that is predicted to be in excess. For example, if it is predicted that the memory resources will run short and the CPU resources will be in excess, a cell 143 is selected as the horizontal item 141 corresponds to the memory and the vertical item 142 corresponds to the CPU.

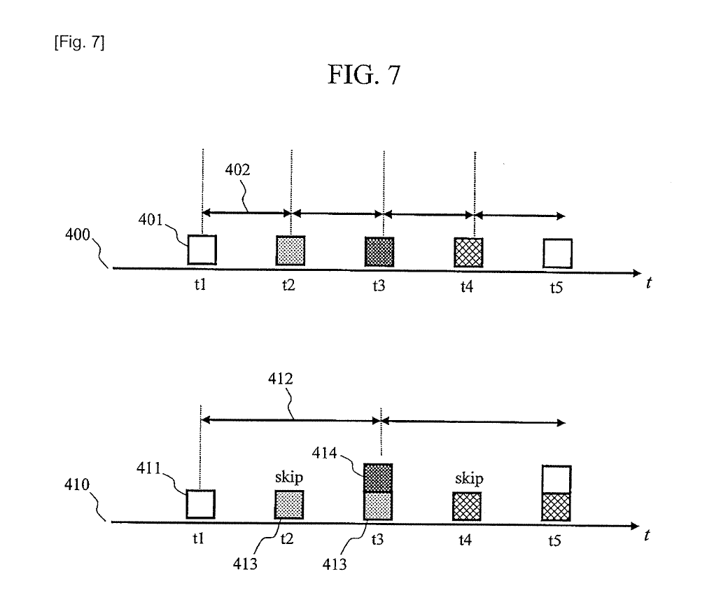

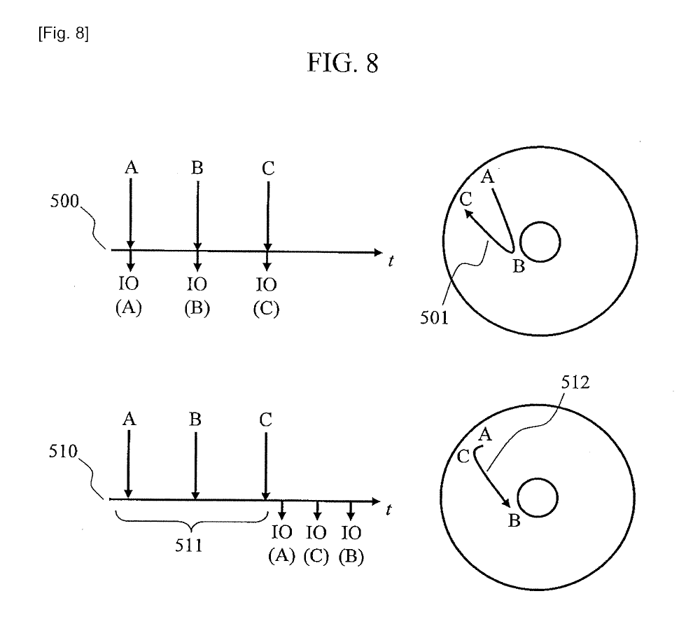

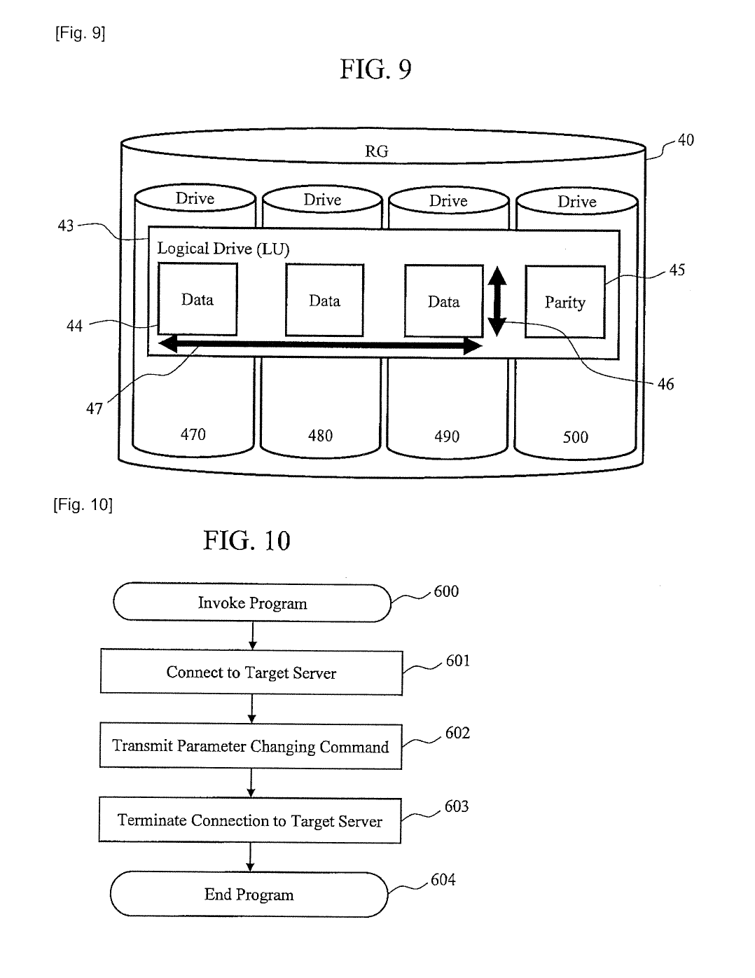

Each cell of the server configuration table 140 has described therein a specific adjustment parameter about how to adjust the server program 110 and its OS in the relevant circumstance, and a value thereof. For example, in cells 143 and 144, an I/O scheduling cycle, which is described later (see FIG. 7), is described as an adjustment parameter. In cells 145 and 146, a block I/O queue length, which is described later (see FIG. 8), is described as an adjustment parameter. Further, in cells 147 and 148, a block I/O alignment setting, which is described later (see FIG. 9), is described as an adjustment parameter. It should be noted that unless an adjustment parameter is specified in particular, a cell can be blank, or adjustment parameters other than those described above, or a plurality of adjustment parameters can be described in the cell. Further, an adjustment parameter is not limited to a constant, and can be a value calculated dynamically based on a function that uses as an argument an adjustment parameter of the virtual hardware 102 and software on the virtual hardware 102, the amount of resources allocated to the virtual hardware 102, or the resource consumption amount.

Further, although the aforementioned example of the table has two dimensions that are the horizontal item 141 and the vertical item 142, it is also possible to create an n-dimensional table by adding an axis indicating a disk configuration, i.e., whether the type of the disk used is a RAID configuration, a stand-alone hard disk, or a semiconductor drive, an axis indicating the type of a service of the server program 110, i.e., whether the server program 110 is a Web server, a database, or the like, and an axis indicating the type of an OS on the server program 110. As the disk configuration, the type of a service, and the type of an OS can be acquired with SNMP or the like, an adjustment parameter can be determined by selecting a single cell from the n-dimensional table.

<Operation of the Adjustment Parameter>

Hereinafter, how the aforementioned adjustment parameter will act depending on whether a shortage of resources is predicted or an excess of resources is predicted will be specifically described.

(i) Role of Setting the I/O Scheduling Cycle.

FIG. 7 is a diagram for illustrating the role of setting an I/O scheduling cycle. An I/O scheduling cycle is a configuration parameter of the server program 110 or its OS, which is the execution intervals of periodic I/Os performed for real-time data transmission and reception that are necessary in image distribution, image reception, and the like, in particular. A time line 400 in FIG. 7 indicates a state in which data 401 is periodically processed on an I/O scheduling cycle 402. When the I/O scheduling cycle 402 is changed, whether to use more memory resources or use more CPU resources will change. Hereinafter, a specific example in an image distribution service will be described.

Assume that the time line 400 represents a state in which the image data 401 is read from a disk device on the cycle 402. In such a case, when data is transmitted to a network on the same cycle as the cycle 402 of the time line 400, memory space corresponding to the size of the data 401 will be consumed.

Meanwhile, when data reading from a disk is performed on the cycle 402 as indicated on the time line 400, and data transmission to a network is performed on a cycle 412 that is twice as long as the cycle 402 as indicated on a time line 410, I/O to the network is not executed at the point when image data 413 is read from a disk after image data 411 has been transmitted. Then, at the timing when data 414 is read from a disk, both the data 413 and the data 414 are transmitted to the network. That is, as the I/O scheduling cycle is longer, the number of times I/O processes are executed will decrease, resulting in a lower CPU load. However, as the data is processed collectively, the amount of memory space used will increase. Meanwhile, as the I/O scheduling cycle is shorter, the response of the server program 110 will be faster. Thus, the I/O scheduling cycle can also be used as an adjustment parameter for when the response performance is deficient.

(ii) Role of Setting the Block I/O Queue Length

FIG. 8 is a diagram for illustrating the role of setting a block I/O queue length. A block I/O queue length is a configuration parameter of the server program 110 or its OS. That is, when data posted by the client terminal 10 is to be recorded on the highcapacity storage device 40 such as a hard disk, for example, the number of block I/Os that are temporarily held to efficiently issue a data write request (block I/Os) corresponds to the parameter. If the block I/O queue length is 1, only a single block I/O can be held. Thus, block I/Os should be sequentially issued. Meanwhile, as the block I/O queue length is longer, more block I/Os can be temporarily held. Thus, it is possible to increase the efficiency of data writing by changing the issue order of block I/Os. Hereinafter, advantageous effects produced by the adjustment of the block I/O queue length will be described in detail.

When the block I/O queue length is 1, for example, three block I/Os (A, B, and C) are sequentially issued to a hard disk as indicated on a time line 500. Thus, data is written while a head is sequentially moved from A to B, and then to C as shown on a disk surface 501 of a hard disk. As the B is located physically far, the head should travel between the locations where the A and C are recorded and the location where the B is recorded.

Meanwhile, when the block I/O queue length is increased to three or more, it becomes possible to issue I/Os by changing the order to A, C, B as indicated on a time line 510 at a later timing than a timing 511 when the I/Os to the A, B, and C were issued. At this time, as the traveling order of the head becomes A, C, B as indicated on a disk surface 512 of a hard disk, it is possible to reduce the head travel distance to half. That is, increasing the block I/O queue length can improve the disk performance. However, as a plurality of block I/Os is stored, the memory space used would increase and the response performance would degrade.

(iii) Role of Setting the Alignment of a Block I/O

FIG. 9 is a diagram for illustrating the role of setting the alignment of a block I/O. The alignment setting of a block I/O is a configuration parameter of the server program 110 or its OS. When the storage device 40 has a RAID (Redundant Arrays of Inexpensive Disks) configuration with a plurality of drives 470 to 500, data 44 and a parity 45 are recorded in units of a stripe size 46 on a logical drive 43 that is implemented on the RAID group. Accordingly, even if any of the drives 470 to 490 has failed, data in the failed drive can be restored from the data 44 and the parity 45 in the remaining drives.

However, as a parity is created in units of the stripe size 46 in the RAID configuration, the disk performance would greatly differ depending on whether or not data is recorded in units of a stripe row size 47, which is a data length corresponding to a single parity. When data is to be written along a stripe row, only a single write operation to each drive is required, inclusive of a parity. However, when data of half the size of the stripe row size is to be written, for example, it is necessary to read a half of the data, which is not to be overwritten, on the storage device 40, calculate a parity from the read data and the data to be written, and then write the data to the disk. That is, in order to write data once, both reading and writing are generated.

When alignment is carried out by the block I/O alignment setting, it becomes possible to combine a plurality of write requests and issue I/O with an offset position and size that match the stripe row as much as possible. Accordingly, the available disk bandwidth can be increased. However, as the data to be written is positioned at the head of a stripe row, or a plurality of pieces of data is combined, a data copy may be generated, which could increase the CPU load or degrade the response performance.

(iv) As described above, adjusting the configuration of the server program 110 and/or the OS in advance before a shortage of resources actually occurs allows switching of the type of resources to be consumed.

It should be noted that in addition to the aforementioned adjustment parameters, any configuration parameters of the server program 110 and/or the OS can be applied to switch the resources to be consumed. For example, a data compression communication setting of a Web server is a function of reducing the network load by reducing the amount of data to be transmitted. However, if an increase in the CPU load is considered as a side-effect, such a function can be regarded as a parameter for switching between CPU resources and network bandwidth resources. Further, if a file compression recording function is activated, a CPU load will increase, but the amount of consumption of the disk bandwidth will decrease as the amount of data to be written is reduced. Alternatively, if the maximum number of concurrent issues of asynchronous I/Os for issuing the next I/O without waiting for the completion of I/O that has been previously issued to access a disk is reduced, the available disk bandwidth will decrease, but the response performance will improve. Further, if intervals of generations of hardware interrupts by a device driver, which is adapted to inform software of the completion of I/O, are shortened, the CPU load will increase, but the response performance will improve.

<Server Configuration Adjustment Process>

FIG. 10 is a flowchart for illustrating a server configuration adjustment process with the server configuration adjustment program 132. The server configuration adjustment program 132 is started when invoked from step 207 of the main program 131 (step 600). At this time, the main program 131 specifies the address for connection to the target server program 110 and the OS (software on the VM 102) whose configuration is to be adjusted, and a specific parameter adjustment content (which includes information about the adjustment amount of a parameter determined using the server configuration table 140).

Each virtual hardware 102 on the hypervisor 101 can communicate with each other in the same way as it communicates with other devices via the network 50. Thus, the server configuration adjustment program 132 is connected to a target server whose configuration is to be adjusted (e.g., a server that is predicted to run short of resources and thus to be subjected to load adjustment) using the specified address (step 601).

Next, the server configuration adjustment program 132 backs up the current value of the specified adjustment parameter via a configuration interface of the server program 110 and the OS, and changes the value (step 602).

Then, the server configuration adjustment program 132 terminates the connection to the target server (step 603), and terminates the process (step 604).

For the configuration interface of the server program 110 and the OS, various methods can be used such as a method of, after rewriting a text-format configuration file, causing the configuration file to be read again (if a configuration file of the server program 110 is rewritten, the configuration value will be changed upon reboot), a method of executing a configuration command, and a method of directly writing a configuration value to a imaginary control file, which is called a device file. With such a method, the configuration value can be changed.

The adjustment parameter can be backed up by, if it is a text-format configuration file, leaving a file of the old version on the storage device 40. Further, if a configuration command is executed, the content of the command that has been executed in advance may be left in text-file format, so that it can be used as a backup when the command is executed next. When a device file is used, the latest value is read out from the device file and written into a text file, or a value to be written to the device file is stored in text-file format in advance, so that it can be used as a backup when a value is written to the device file next.

<Performance Prediction Process>

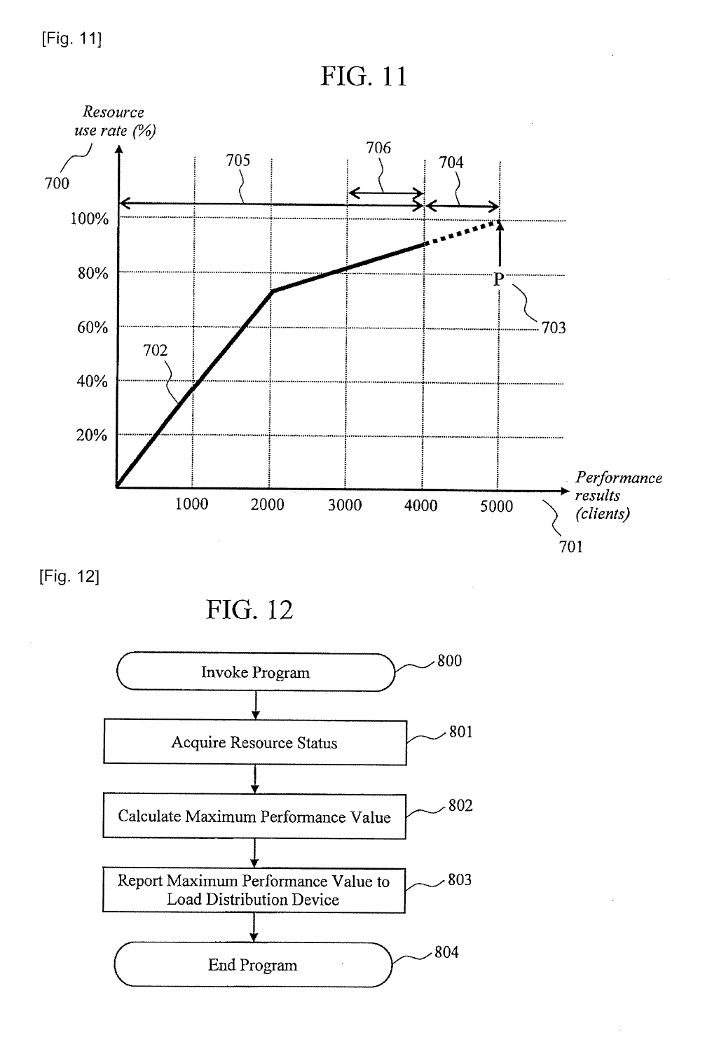

FIG. 11 is a conceptual diagram for illustrating a method of predicting the maximum performance of a server with the performance prediction program 133. In FIG. 11, the vertical axis 700 indicates the resource consumption rate (use rate), while the horizontal axis 701 indicates the number of client terminals connected to a server (performance results).

Typically, when the number of client terminals 10 connected to the server 30 increases, the resource consumption rate increases correspondingly. Thus, if the resource consumption rate of when the server 30 is approaching its limit performance is plotted, a graph 702 can be drawn from the lower left to the upper right. When such a graph 702 is approximated to a function using a least-squares method or the like, it becomes possible to predict the number 703 of connected client terminals when the resource consumption rate is the maximum.

In FIG. 11, the predicted value 703 can be calculated by drawing the aforementioned graph for all resources including the CPU, memory, disk bandwidth, and the like. Among such resources, a point (resource) with the minimum value (the smallest number of connected client terminals) corresponds to the maximum performance (limit performance) of the server 30.

For the prediction of the maximum performance, methods other than the aforementioned approximation with the least-squares method can also be used. Typically, the amount of resources consumed by the control module 130 is sufficiently smaller than that consumed by the server program 110. Thus, the predicted section 704 is sufficiently shorter than the actual measured section 705. Thus, the section 704 can be predicted using only the actual measured value of the nearest section 706 corresponding to the length of the performance-predicted section 704. In particular, when the resource consumption amount changes nonlinearly with respect to an increase in the number of client terminals, it is preferable to narrow the actual measured value section, which is used for the prediction, down to the nearest section as described above.

FIG. 12 is a flowchart for illustrating a performance prediction process with the performance prediction program 133. The performance prediction program 133 is started when invoked from step 213 of the main program 131 (step 800).

The performance prediction program 133 references the resource management table 120 to acquire the used amount of each resource (step 801). The acquired amount of the used resources is stored in memory together with the number of the currently connected client terminals 10 so that it can be used when the performance prediction program 133 is invoked again. The number of the currently connected client terminals 10 can be acquired from any server program 110 using a typical network device management protocol such as a simple network management protocol (SNMP).

Next, the performance prediction program 133 calculates the maximum performance value with the aforementioned least-squares method (see FIG. 11) or the like using the amount of the used resources and the number of the connected client terminals that have been stored (step 802).

The performance prediction program 133 informs the load distribution device 20 of the calculated maximum number of connected client terminals (step 803). Accordingly, the load distribution device 20 can be controlled so as not to allocate the client terminals 10 beyond the limit performance of the server program 110. Specifically, the number of the currently connected client terminals 10 can be acquired from the server program 110 using the aforementioned SNMP. Thus, the load distribution device 20 compares the number of the currently connected client terminals 10 with the aforementioned maximum number of connected client terminals, and if the number of the currently connected client terminals 10 reaches the maximum number of connected client terminals, the load distribution device 20 performs a control such that the client terminals 10 are not informed of the address of the server program. It should be noted that the performance prediction program 133 can also be configured to inform the server program 110 of the maximum number of connected client terminals, and the server program 110 can be configured to refuse a receipt of the connection. However, since some load would be imposed on the server 30 even by the refusal of the rejection, it is preferable to, if the load distribution device 20 is available, use the load distribution device 20 to prevent the server from being overloaded.

Through the aforementioned steps, the process of the performance prediction program 133 terminates (step 804).

<Resource Allocation Adjustment Process>

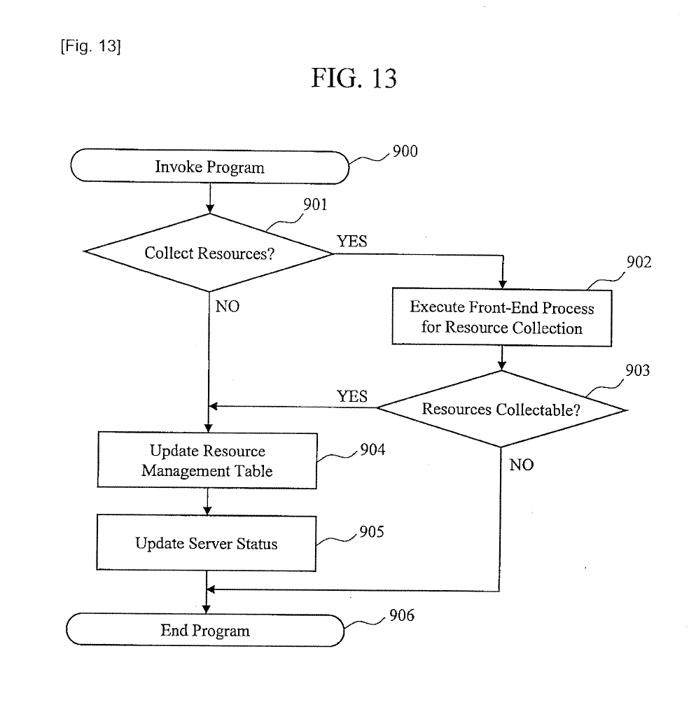

FIG. 13 is a flowchart for illustrating a resource allocation process with the resource allocation adjustment program 134. The resource allocation adjustment program 134 is started when invoked from step 210 of the main program 131 or step 1003 of the control module booting/halting program 170 (step 900). When the resource allocation adjustment program 134 is invoked, an instruction to collect resources or add resources (allocate resources) is issued by an argument of the main program 131, which is an invoker. When the instruction is the collection of resources, the type of resources to be collected and the identifier 121 of the target virtual hardware 102 are given, while when the instruction is the addition of resources, the type of resources to be added, the amount of resources to be added, and the identifier 121 of the target virtual hardware 102 are given. It should be noted that the amounts of resources to be collected and added by a single resource allocation process are based on the update unit amount determined by the initialization.

First, the resource allocation adjustment program 134 checks if the instruction received is an instruction to collect or add resources (step 901).

If the instruction is the collection of resources (if the answer to step 901 is Yes), the resource allocation adjustment program 134 instructs the server program 110 and its OS on the virtual hardware 102, which can be identified from the specified hardware identifier 121, to execute a front-end process for collecting resources such as garbage collection (step 902). The garbage collection is executed periodically by the server program 110 and its OS. However, it is also executed again when determining if collection of resources is possible. Garbage collection is necessary as the amount of resources that can be used continuously cannot be known immediately although the amount of unused resources can be known from the use rate.

Then, the resource allocation adjustment program 134 determines if the collectable resources have been successfully secured, from the result of the front-end process in step 902 (by acquiring the result of the garbage collection from the target server program 110 or the like) (step 903). If it is determined that the resources have not been successfully secured (if the answer to step 903 is No), the resource allocation adjustment process terminates.

If it is determined that the resources have been successfully secured (if the answer to step 903 is Yes), the resource allocation adjustment program 134 updates the resource management table 120 (step 904), and informs the server program 110 and its OS on the virtual hardware 102 of the completion of the collection of the resources (step 905).

Meanwhile, if the addition of resources is instructed by the argument of the main program 131 (if the answer to step 901 is No), the resource allocation adjustment program 134 updates the resource management table 120 in the same way as in the case of collecting resources, to add a specified amount of resources of the specified type to the specified virtual hardware 102 (step 904), and informs the server program 110 and its OS of the completion of the collection of the resources (step 905).

Through the aforementioned steps, the process of the resource allocation adjustment program 134 terminates (step 906).

<Process of Booting/Halting the Control Module>

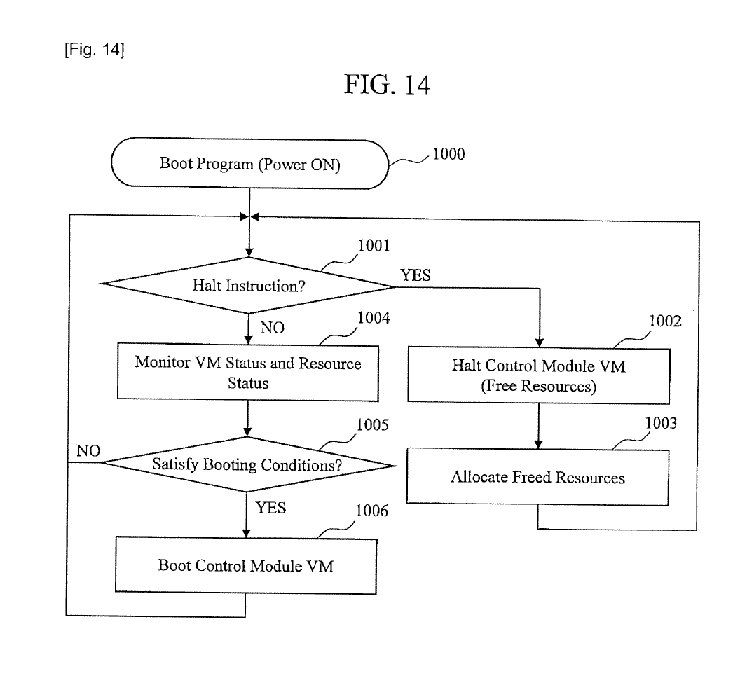

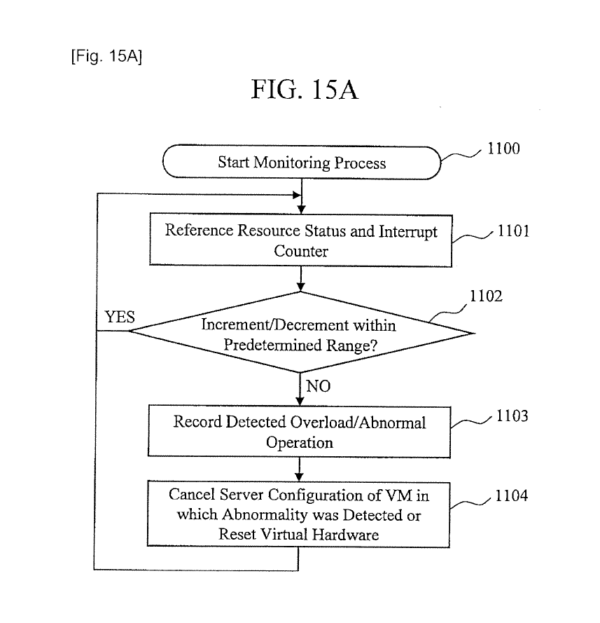

FIG. 14 is a flowchart for illustrating a process of booting/halting the control module 130 with the control module booting/halting program 170. The control module booting/halting program 170 is initiated when the power is turned ON, independently of the main program 131 (step 1000).

Then, when an instruction to halt the virtual hardware 102 is received from the main program 131, the control module booting/halting program 170 receives the halt instruction (step 1001), and then performs a process of halting the virtual hardware 102 (step 1002).

The control module booting/halting program 170, upon receiving an instruction to reallocate the resources allocated to the virtual hardware 102, which has been halted by the halt instruction, to another virtual hardware 102, invokes the resource allocation adjustment program 134 to execute allocation of the resources to the specified virtual hardware 102, and further informs the associated server program 110 and its OS of the addition of the resources to the virtual hardware 102 (step 1003). At this time, the amount of each resource allocated to the virtual hardware 102 that executes the control module 130 is stored in memory so that it is used for re-starting the control module 130 in step 1005 described later.

Meanwhile, if there is no halt instruction (if the answer to step 1001 is No), the control module booting/halting program 170 references the resource management table 120 to check the operating status of the control module 130 and the usage status of each resource (step 1004).

The control module booting/halting program 170 checks if the virtual hardware 102 that executes the control module 130 is in a halt state and if the available amount of each resource is sufficiently higher than the actual measured value of the past resource consumption amount stored in the memory in step 1003 (step 1005).

If such conditions are satisfied (if the answer to step 1005 is Yes), the control module booting/halting program 170 boots the virtual hardware 102 to re-execute the control module 130 (step 1006), and repeats the procedures from step 1001.

It should be noted that the virtual hardware 102 can be halted by writing the CPU status, the I/O interface status, and the memory status to the storage device, while the virtual hardware 102 can be re-started by reading the CPU status, the I/O interface status, and the memory status that have been written to the storage device in advance. In such a case, the virtual hardware 102 can be re-started from the state immediately before it was halted, which is advantageous in that the virtual hardware 102 can be re-started at fast speed.

<Monitoring Process and Interrupt Handling>

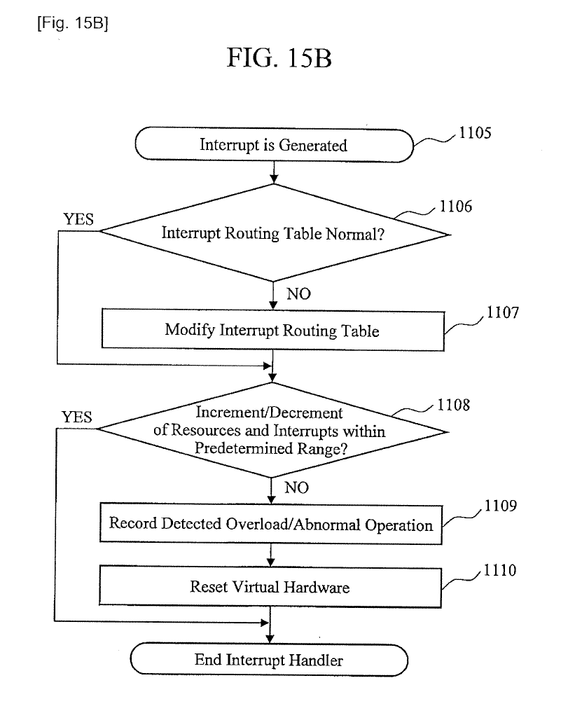

FIGS. 15A and 15B are flowcharts for illustrating a monitoring process (FIG. 15A) and interrupt handling (FIG. 15B) performed by the virtual hardware protection program 135. The virtual hardware protection program 135, when an unexpected abnormal operation occurs due to a change in the server configuration, cancels the change of the server configuration or resets the virtual hardware 102 that has caused the abnormal operation, thereby preventing the entire server 30 from being unable to provide services continuously due to the influence of the abnormal operation.

Typically, when the physical hardware 100 is completely hid from the virtual hardware 102 by the hypervisor 101, a problem that occurs on specific virtual hardware 102 would not influence other virtual hardware 102. Therefore, the aforementioned problem does not seem to occur.

However, in such a case, overhead incurred by the presence of the hypervisor 101 between the server program 110 and the hardware 100 would increase, so that the original objective of maximizing the potential performance of the hardware 100 cannot be attained. It is therefore necessary that software on the virtual hardware 102 should directly control part of the hardware 100 such as a network device so that the overhead incurred by the presence of the hypervisor 101 can be reduced. Thus, there is a risk that the entire server 30 may go down as described above. More specifically, if the hardware 100 operates abnormally during the process of changing the configuration of the hardware 100, which is directly controlled by the virtual hardware 102, it is possible that an abnormal interrupt may be generated for other virtual hardware 102. In such a case, depending on the frequency of generation of interrupts, the virtual hardware may not be able to execute the intended process. Besides, as there are various factors that the software may not operate as intended in a particular configuration such as, for example, a mere program failure or a failure of the hardware 100, it is vital to provide a mechanism in which the server 30 can be restored even if it has operated abnormally. Hereinafter, detailed operation of the virtual hardware protection program 135 will be described.

Operations of the virtual hardware protection program 135 include the two following operations: an operation in which the program is started when the power is turned ON, independently of the main program 131 (step 1100 to step 1104), and an operation in which the program is started at the moment when an abnormal interrupt is generated (step 1105 to step 1111). Such operations can be performed independently of each other.

(i) Monitoring Process (FIG. 15A)

First, an operation performed at the moment when the power is turned ON will be described. When a process is started at the moment when the power is turned ON (step 1100), the virtual hardware protection program 135 references the resource management table 120 to acquire a list of the virtual hardware 102, and checks the increment of each resource and the number of interrupts generated in each virtual hardware 102 (step 1101). The number of interrupts is acquired from the statistical information on the number of interrupts that is managed by the virtual hardware status monitoring program 160 of the hypervisor 101. The virtual hardware status monitoring program 160 operates within the hypervisor that implements the virtual hardware. Thus, the virtual hardware status monitoring program 160 can reference the internal state of any given virtual hardware and collectively manage it as the statistical information. In addition, the increment of resources can be acquired by holding the amount of resources when the resource management table 120 was referenced previously, and determining the difference between the current amount and the previous amount.

The virtual hardware protection program 135 determines if the increment/decrement of the frequency of generation of interrupts and the resource consumption is within a predetermined range (step 1102), and if the increment/decrement is determined to be within the predetermined range, repeats the procedures from step 1101 again.

Meanwhile, if the increment/decrement is determined to be outside the predetermined range (if the answer to step 1102 is No), the virtual hardware protection program 135 records information about the detected abnormal operation (step 1103), and cancels the previous server configuration (configuration parameter) of the virtual hardware 102 or resets the entire virtual hardware 102 (step 1104). Recording of an abnormal operation can be accomplished by recording it on a log file on the storage device 40, transmitting it to another server via the network 50 using the existing techniques such as SYSLOG, or by a combination thereof. Meanwhile, cancellation of the previous server configuration can be accomplished by a method of restoring the server configuration to the previous configuration using a virtual hardware status snapshot function of the hypervisor 101, or a method of restoring the server configuration to the original configuration by merely referencing the backup of the previous configuration. Further, which of the cancellation of the server configuration and the reset of the virtual hardware 102 should be executed can be determined by selecting either one of them in advance, or preparing two-stage thresholds in step 1102 so that the virtual hardware 102 is reset based on a criteria that is above the cancellation criteria of the server configuration. Further, in order to further increase the reliability, failover can be performed prior to the reset of the hardware, so that services can be continued with the server program 110 on another virtual hardware 102.

(ii) Interrupt Handling (FIG. 15B)

Next, an operation performed at the moment when an abnormal interrupt is generated will be described. This process is started at the moment when an interrupt with an interrupt number, which should not occur under normal circumstances, is generated (step 1105).

First, the virtual hardware protection program 135 checks if a table called an interrupt routing table, which defines the destination of an interrupt, of the hardware 100 including a CPU is broken (step 1106).

If an abnormality is determined to be present (if the answer to step 1106 is No), the virtual hardware protection program 135 modifies the interrupt routing table (step 1107). Specifically, the virtual hardware protection program 135 creates a backup of the interrupt routing table in a write-inhibited area on memory in advance, and compares the table content with the backup, whereby it is possible to check if the table is broken, acquire a normal value, and overwrite the table. The write-inhibited area can be easily realized by using a paging function or a segmentation function of a typical CPU.

Meanwhile, if an abnormality is determined to be absent (if the answer to step 1106 is Yes), the process proceeds to step 1108.

Then, the virtual hardware protection program 135 checks if the increment/decrement of resources and interruptions is within a predetermined range (step 1108) as in step 1101 to step 1104, and, if the increment/decrement is determined to be outside the range, records the abnormal operation (step 1109), and resets the virtual hardware 102 in which the abnormality was detected (step 1110). At this time, if there is any hardware 100 (I/O interface) that is directly controlled by the relevant virtual hardware 102, the virtual hardware protection program 135 also resets the hardware 100 (I/O interface).

Through the aforementioned steps, the virtual hardware protection program 135 terminates the interrupt handling (step 1111).

<Initialization Process>

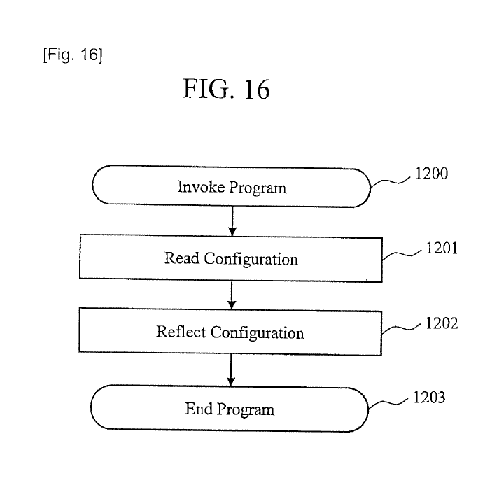

FIG. 16 is a flowchart for illustrating an initialization process performed by the initialization program 136. The initialization program 136 is started when invoked from step 202 of the main program 131 (step 1200).

Then, the initialization program 136 reads the configuration (step 1201), sets (reflects) the read configuration on (in) a variable of the associated program (step 1202), and terminates the program (step 1203).

Herein, reading of the configuration in step 1201 can be accomplished by reading a configuration file stored in the storage device 40 or through an entry by an administrator of the server 30 using a monitor or an input device of the server 30. Alternatively, configuration data can be downloaded from another server 30 via the network 50, or a combination of them can be performed.

### (2) Second Embodiment

The first embodiment of the present invention showed that the present invention can be advantageously applied to a case in which allocation of resources to virtual hardware should be continuously adjusted dynamically when, for example, services are provided to an indefinite number of client terminals over the Internet. The second embodiment will show that the present invention can also be applied to a case in which optimum hardware resources can be statically allocated in advance when, for example, services are provided to a particular client terminal over an intranet.

<System Configuration>

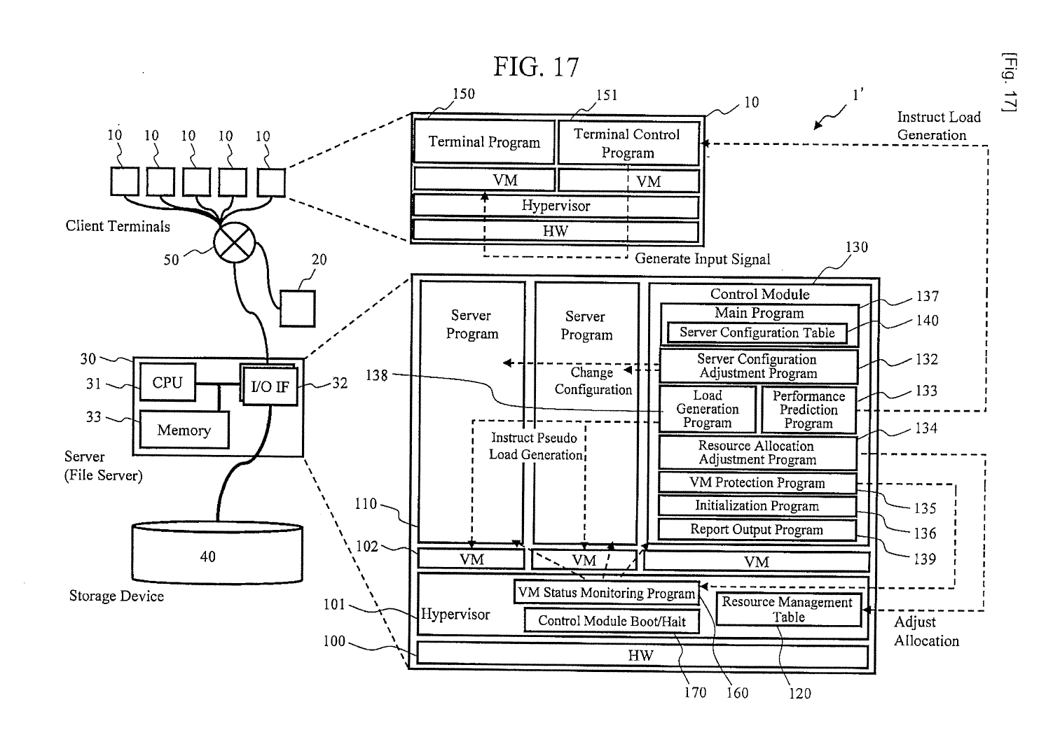

FIG. 17 is a diagram showing an exemplary configuration of a computer system 1′ in accordance with the second embodiment of the present invention. The computer system 1′ corresponds to an exemplary system constructed for the purpose of automating an in-plant tuning operation performed before a product shipment of the server device 30 or an on-site adjustment operation of the server device 30. That is, in a configuration with given fixed client terminals 10 and a network 50, if one attempts to configure the server 30 such that it can satisfy the performance requirement required by the configuration, it is possible to adequately and automatically configure the server 30 as the inherent performance of the hardware can be maximized according to this embodiment. Meanwhile, if the server 30 cannot be configured adequately by the present invention, it means that additional hardware is needed to satisfy the performance requirement. Thus, reporting the type of deficient resources can provide useful information in the tuning operation.

The computer system 1′ in accordance with the second embodiment basically has the same configuration as the computer system 1 in accordance with the first embodiment. However, instead of the main program 131 in the first embodiment, a second main program 137 whose operation algorithm differs from that of the main program 131 is provided. In addition, two programs (a load generation program 138 and a report output program 139) invoked from the main program 137 are newly added.

The load generation program 138 has a function of imposing a load on the server 30 that executes the main program 137 via a terminal control program 151 of the client terminal 10, and also has a function of, when there is no client teiniinal 10 connected, issuing an instruction to generate a pseudo load. The control module 130 can automatically perform a series of adjustment operations that includes adjusting the configuration of the server program 110, actually imposing a load to verify if the performance can satisfy the predetermined performance requirement, and outputting the result as a report.

If the client terminal 10 has a hypervisor as shown in the drawing, it is possible to easily build the terminal control program 151 into the client terminal 10 by providing the terminal control program 151 on dedicated virtual hardware, separately from the terminal program 150 that is the original program of the terminal 10. However, the terminal control program 151 can also be directly built in the terminal program 150, or if the terminal control program 151 is difficult to be built therein, the terminal control program 151 can be omitted as described below to carry out the present invention.

<Process of the Control Module>

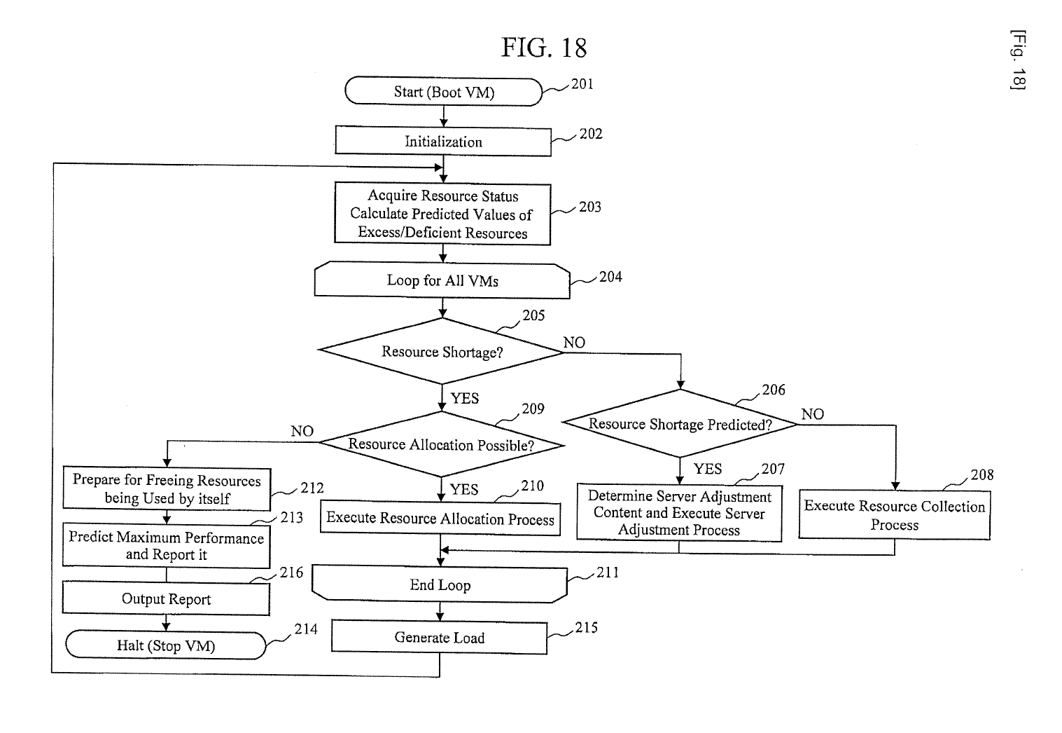

FIG. 18 is a flowchart for illustrating the process of the main program 137 that is the central to the control module 130 in accordance with the second embodiment of the present invention. Unlike the first embodiment, the second embodiment includes additional steps 215 and 216. Described below are only processes that differ from those in the first embodiment (FIG. 4).

In step 215, the main program 137 invokes the load generation program 138 described below, and executes a process of increasing a load (e.g., the number of client terminals 10 connected to the server 30) in stages so that the load will finally reach a load specified by the performance requirement.

In step 216, the main program 137 outputs the maximum performance predicted in step 213, the final server adjustment content, and the resource allocation content with the report output program 139 described below.

That is, gradually increasing a load can adjust the server configuration and the resource allocation described in the first embodiment, and output as a report the maximum performance and the optimum server configuration and resource allocation.

<Load Generation Process>

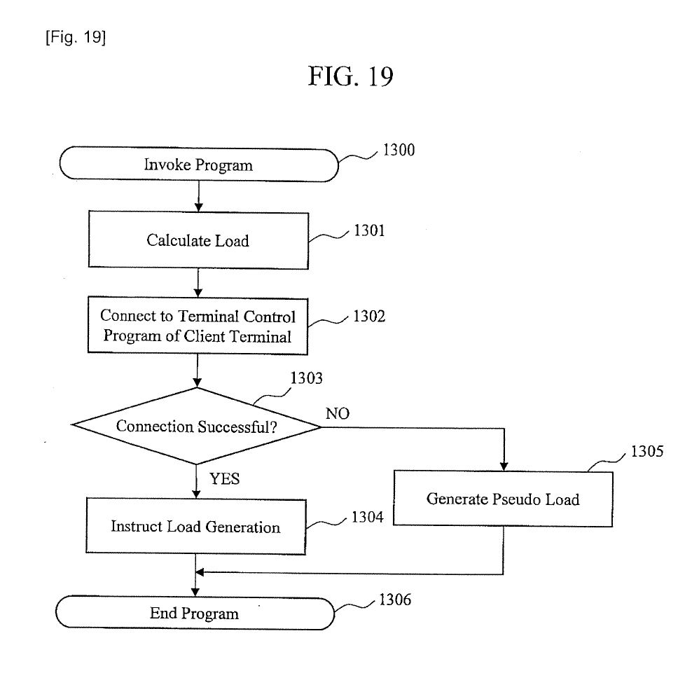

FIG. 19 is a flowchart for illustrating a load generation process with the load generation program 138. This program is started when invoked from step 215 of the main program 137 (step 1300).

First, the load generation program 138 acquires the performance requirement given as the initial value in step 202, and calculates the increment of the connected clients in a single stage (step 1301). The increment of the connected clients in a single stage is the information for increasing the number of the connected clients to the maximum number of connected clients, which is specified as the performance requirement, in stages. For example, if a load is increased in n stages, the increment can be defined as max (1, the maximum number of connected clients defined by the performance requirement/n), using a function max (x,y) that returns a larger number of the arguments. Using such a function allows a stepwise increment of the load.

Next, the load generation program 138 attempts a connection to the terminal control program 151 on the client terminal 10 (step 1302).

If a connection is successful (if the answer to step 1303 is Yes), the load generation program 138 instructs the terminal control program 151 to generate a load by the aforementioned increment (step 1304). The terminal control program 151, if a signal of an input device such as a switch of the client terminal 10 is generated in the client terminal 10 via the hypervisor, or if the terminal control program 151 is built in the terminal program 150, directly invokes the terminal program 150 to operate the terminal program 150, whereby the client terminal 10 can be connected to the server program 110 to impose a load.

Meanwhile, if a connection has failed (if the answer to step 1303 is No), the load generation program 138 determines that the terminal control program 151 is not usable. Then, the load generation program 138 creates a state in which a load is imposed in a pseudo manner by generating a signal, which is similar to a signal sent to the server program 110 by the terminal program 150, in the server 30 or by connecting the load generation program 138 directly to the server program 110 (step 1305).

Through the aforementioned steps, the load generation program 138 terminates the process (step 1306).

<Report Output Process>

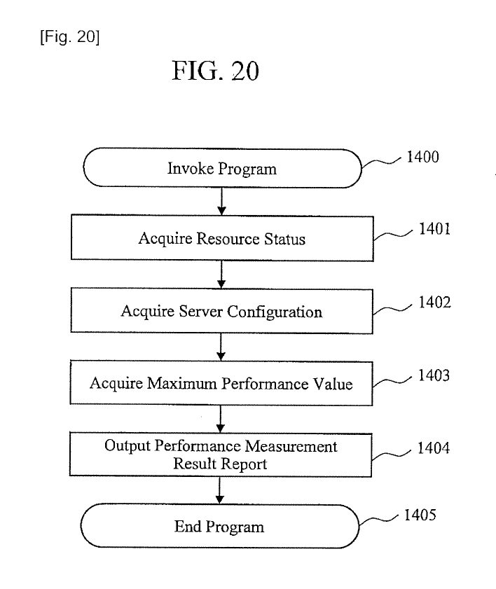

FIG. 20 is a flowchart for illustrating a report output process with the report output program 139. This program is started when invoked from step 216 of the main program 137 (step 1400).

First, the report output program 139 references the resource management table 120 to acquire the resource allocation status of each virtual hardware 102 on the server 30 (step 1401).

Next, the report output program 139 acquires the latest configuration value of the server program 110 and the maximum performance value calculated in step 213 of the main program 137 from each program (step 1402 to step 1403).

Then, the report output program 139 outputs a series of the acquired information as a performance estimation result report (step 1404). The report can be output as a file on the storage device 40 or output to another device via the network 50 with a protocol such as the aforementioned SYSLOG or electronic mail. Alternatively, the report can be output directly onto paper via a device connected to the network 50 such as a printer.

It should be noted that the load generation process (FIG. 19) and the report output process (FIG. 20) are executed on the control module 130. Thus, resource consumption accompanying such processes is included in the resources allocated to the virtual hardware 102 that executes the control module 130. Thus, the maximum performance predicted in step 213 of the main program 137 corresponds to that when the control module 130 is halted and the associated resources are released. Therefore, there is no possibility that the maximum performance would be estimated low due to the influence of the load generation or the report output.

<Report of the Performance Measurement Result>

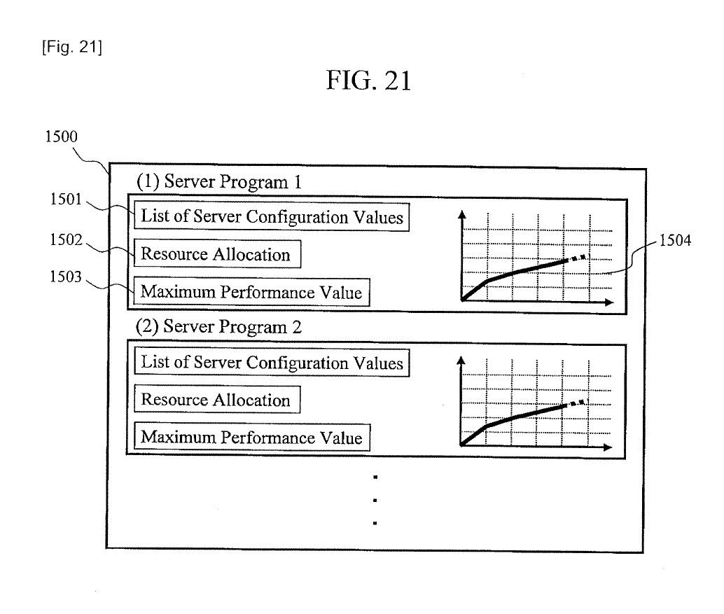

FIG. 21 is a diagram showing an exemplary report of a performance measurement result. A performance measurement result report 1500 contains a list 1501 of a final server configuration value for each virtual hardware or each server program, resource allocation 1502, maximum performance value 1503, and a graph 1504 that visualizes such information.

The graph 1504 shows the result of the performance prediction process in which the vertical axis indicates the resource consumption (use) rate and the horizontal axis indicates the number of connected clients as shown in FIG. 11, for example. The graph 1504 includes, in addition to the data on each virtual hardware 102 or each server program 110, the statistical maximum performance or a graph of the entire server 30 and the like.

### (3) Conclusion

According to this embodiment of the present invention, a plurality of virtual servers is provided on a server system. Physical hardware is virtually allocated to each virtual server (virtual hardware). Such virtual hardware includes the elements such as shown in FIG. 3 (except for the status flag). Based on the use rate of the virtual hardware, a virtual server that is short of resources is detected (detected by a comparison with a predetermined threshold, for example). In addition, excess resources that can be additionally allocated are also calculated from on the current use rate. Further, based on the information on the excess resources, it is determined if allocation of the additional resources to the virtual server, which is short of resources, is possible. If the allocation of the additional resources to the virtual server is determined to be impossible, the virtual hardware allocated to the virtual server is released and the operation of the virtual server is halted. Further, the amount of resources that are necessary for a resource adjustment process is calculated dynamically, and if the load on the virtual server has become lower than the amount of resources necessary for the resource adjustment process, the resource-balancing process is re-started. Accordingly, it becomes possible to adequately allocate hardware resources in a well-balanced manner to the virtual hardware of the virtual server that operates on the physical hardware.

In addition, for each of the plurality of virtual servers, the future use rate of the virtual hardware is predicted based on information on the past use rate thereof (see FIG. 5). Next, bottleneck resources and excess resources are predicted based on the predicted future use rate. From a combination of the bottleneck resources and the excess resources (see the matrix in FIG. 6), an adjustment parameter (adjustment condition) for the server configuration of the virtual server is acquired. Such an adjustment parameter is determined in advance for each combination, for example. Then, the server configuration of the virtual server is adjusted in accordance with the acquired adjustment parameter. Accordingly, it becomes possible to adequately allocate resources in accordance with the future predicted bottleneck and excess resources. That is, even if a shortage of memory space in the near future is predicted, the amount of memory allocation is not simply increased, but allocation of resources can be realized taking into consideration the efficient use of other hardware resources as well.

Further, even when a plurality of virtual servers is integrated on a single piece of physical hardware, it is possible to solve the problem with the conventional method that specific virtual hardware would run short of resources even though there is a sufficient amount of hardware resources of the physical hardware, and to achieve a server integration effect in accordance with the inherent performance of the physical hardware. It should be noted that the adjustment parameter can also be determined by taking into consideration the configuration of a storage device used by the server system and at least one of a server program and a type of an OS on the virtual server in addition to the bottleneck and excess resources. Accordingly, more accurate resource allocation adjustment can be realized.

Further, the maximum performance value (limit performance value) that indicates the allowable number of connected client terminals is predicted using the use rate of the virtual hardware (see FIG. 11). The maximum performance value is used to control the number of client terminals connected to each of the plurality of virtual servers. More specifically, the maximum performance value is reported to a load distribution device via a network. The load distribution device is configured to, based on the maximum performance value, control the allocation of connection of client terminals to each of the plurality of virtual servers. Alternatively, each of the plurality of virtual servers can be configured to control connection of the client terminals thereto based on the maximum performance value. Accordingly, loads on the virtual servers can be controlled in a well-balanced manner. That is, it is possible to prevent uneven distribution of the number of client terminals connected to a single virtual server. It should be noted that it is also possible to output the maximum performance value as well as information on the resource allocation status and the server configuration of the virtual hardware corresponding to the maximum performance value (by displaying them on a display screen, printing them, or transferring them to another device on the network). Further, it is also possible to output the relationship between the use rate of the virtual hardware and the number of connected client terminals corresponding to the use rate in a graph form.

Further, in the server system, if the increment/decrement of one of the generations of interrupts and the use rate of the virtual hardware in each virtual server is within a predetermined range is monitored to detect the presence or absence of an overload or an abnormal operation in the virtual server. Then, for a virtual server in which an overload or an abnormal operation is detected, the previous server configuration information is cancelled, or the virtual hardware is reset. The reset of the virtual hardware refers to rebooting the virtual hardware to restore it to an initial status without changing the allocation of the physical hardware (without resetting the physical hardware). Accordingly even a server operation under an improper server configuration or unexpected abnormalities can be handled.

In the server system in accordance with the second embodiment, the maximum performance value of a virtual server is calculated while increasing a load on the virtual server by increasing the number of the connected client terminals in stages, and the maximum performance value is output. Accordingly, a tuning operation performed before a shipment of a server system, and an adjustment operation performed at an installation site can be automated. In an environment in which no client terminal is connected to a virtual server, a load may be generated in a pseudo manner to increase the load on the virtual server.

### REFERENCE SIGNS LIST

10 client terminal
20 load distribution device
30 server
31 CPU
32 I/O interface
33 memory
40 storage device
41 storage control device
42 I/O interface
50 network
100 hardware
101 hypervisor
102 virtual hardware
110 server program
120 resource management table
130 control module
131 main program
132 server configuration adjustment program
133 performance prediction program
134 resource allocation adjustment program
135 virtual hardware protection program
136 initialization program
140 server configuration table
160 virtual hardware status monitoring program
170 control module booting/halting program

1. A server system for providing information to client terminals connected to the server system via a network, comprising:
a processor configured to manage a plurality of virtual servers to each of which a plurality of types of hardware resources is allocated, and operate the plurality of virtual servers based on their respective server configurations; and
memory adapted to have stored therein management information of virtual hardware that is the plurality of types of hardware resources allocated to each of the plurality of virtual servers, wherein
the processor performs:
detecting, based on a use rate of the virtual hardware in each of the plurality of virtual servers, a virtual server that is short of resources, calculating, based on the use rate, excess resources that can be allocated,
determining, based on the calculated excess resources, if allocation of additional resources to the virtual server that is short of resources is possible, and
releasing, if the allocation of the additional resources to the virtual server is determined to be impossible, the virtual hardware allocated to the virtual server and halting the operation of the virtual server.

2. A server system according to claim 1, wherein
the processor further performs:
predicting, for each of the plurality of virtual servers, a future use rate of the virtual hardware based on information on a past use rate of the virtual hardware,
predicting, based on the predicted future use rate, deficient resources and excess resources in the future,
acquiring, based on a combination of the deficient resources and the excess resources, an adjustment condition for the server configuration of the virtual server, and
adjusting, in accordance with the adjustment condition, the server configuration of the virtual server.

3. A server system according to claim 1, wherein
the processor predicts, using the use rate of the virtual hardware in each of the plurality of virtual servers, the maximum performance value that indicates the allowable number of client terminals connected to the virtual server, and
the maximum performance value is used to control the number of the client terminals connected to the virtual server.

4. A server system according to claim 3, wherein the processor reports the maximum performance value to a load distribution device via the network to allow the load distribution device to control, based on the maximum performance value, allocation of connection of the client terminals to each of the plurality of virtual servers.

5. A server system according to claim 3, wherein
the processor reports the maximum performance value to a server program that operates on each of the plurality of virtual servers, and each of the plurality of virtual servers controls connection of the client terminals thereto based on the maximum performance value.

6. A server system according to claim 1, wherein
the processor performs:
detecting, depending on whether an increment/decrement of one of generations of interrupts and the use rate of the virtual hardware in each virtual server is within a predetermined range, the presence of an overload or an abnormal operation in the virtual server, and
canceling, for the virtual server in which the overload or the abnormal operation has been detected, information on the previous server configuration or resetting the virtual hardware.

7. A server system according to claim 2, wherein the processor determines the adjustment condition taking into consideration a configuration of a storage device used by the server system and at least one of a server program and a type of an OS on the virtual server in addition to the deficient resources and the excess resources.

8. A server system according to claim 2, wherein
the adjustment condition for the server configuration includes adjustment of an I/O scheduling cycle, and
the processor, when instructed to adjust the I/O scheduling cycle based on a combination of the deficient resources and the excess resources, adjusts the server configuration of the virtual server so that the I/O scheduling cycle is changed.

9. A server system according to claim 1, wherein
the processor performs the following processes:
calculating, using the use rate of the virtual hardware in each of the plurality of virtual servers, the maximum performance value that indicates the allowable number of client terminals connected to the virtual server, and
outputting the maximum performance value and information on a resource allocation status and the server configuration of the virtual hardware corresponding to the maximum performance value.

10. A server system according to claim 9, wherein
the processor further outputs a relationship between the use rate of the virtual hardware and the number of the connected client terminals corresponding to the use rate in a graph form.

11. A server system according to claim 1, wherein the processor calculates the maximum performance value that indicates the allowable number of client terminals connected to each virtual server while increasing a load on the virtual server by increasing the number of the connected client terminals in stages, and outputs the maximum performance value.

12. A server system according to claim 11, wherein the processor, in an environment in which no client terminal is connected to the virtual server, generates a load in a pseudo manner to increase the load on the virtual server.

13. A server system according to claim 2, wherein the memory includes a response performance value of the virtual server as the management information of the virtual hardware.

14. A method for managing a server system that provides information to client terminals connected to the server system via a network, the server system including a processor configured to manage a plurality of virtual servers to each of which a plurality of types of hardware resources is allocated, and operate the plurality of virtual servers based on their respective server configurations, and memory adapted to have stored therein management information of virtual hardware that is the plurality of types of hardware resources allocated to each of the plurality of virtual servers, the method comprising the following processing steps performed by the processor:
detecting, based on a use rate of the virtual hardware in each of the plurality of virtual servers, a virtual server that is short of resources, calculating, based on the use rate, excess resources that can be allocated,
determining, based on the calculated excess resources, if allocation of additional resources to the virtual server that is short of resources is possible, and
releasing, if the allocation of the additional resources to the virtual server is determined to be impossible, the virtual hardware allocated to the virtual server and halting the operation of the virtual server.

15. A managing method according to claim 14, further comprising the following processing steps performed by the processor:
predicting, for each of the plurality of virtual servers, a future use rate of the virtual hardware based on information on a past use rate of the virtual hardware,
predicting, based on the predicted future use rate, deficient resources and excess resources in the future,
acquiring, based on a combination of the deficient resources and the excess resources, an adjustment condition for the server configuration of the virtual server, and
adjusting, in accordance with the adjustment condition, the server configuration of the virtual server.
